(19) United States
(12) Patent Application Publication
(10) Pub. No.: US 2013/0269488 A1
(43) Pub. Date: Oct. 17, 2013

(54) Ratchet Wrench Capable of Being Operated Through Relatively Smaller Minimum Swing Angle Action

(71) Applicant: NEW WAY TOOLS CO., LTD., Taichung City (TW)

(72) Inventor: Ping-Wen Huang, Taichung City (TW)

(73) Assignee: New Way Tools Co., Ltd., Taichung City (TW)

(21) Appl. No.: 13/744,490

(22) Filed: Jan. 18, 2013

(30) Foreign Application Priority Data
Apr. 13, 2012 (TW) 101113215

(51) Int. Cl. B25B 13/46

(52) U.S. Cl. CPC B25B 13/463
USPC 81/60

(57) ABSTRACT

A ratchet wrench includes a head. A gear wheel, a first pawl, and a second pawl are disposed in a chamber defined in the head. The gear wheel has an outer periphery thereof including a plurality of teeth extended circumferentially outwardly therefrom. The first and second pawls each include a lateral side thereof including third and fourth plurality of teeth respectively extended outwardly therefrom. The first and second pawls are disposed one above the other. The first and second pawls are respectively biased by first and second biasing mechanisms. The first and second pawls are alternatively engaged with the gear wheel when it is operably turned.

### BACKGROUND OF THE INVENTION

1. Field of the Invention

The present invention relates to a ratchet wrench and, in particular, to a ratchet wrench which better withstands torque transmission and is capable of being operated through a relatively smaller minimum swing angle action.

2. Description of the Related Art

TW Patent No. M423025 shows a wrench including a pawl and a gear wheel, and designs of the pawl and the gear wheel determine the minimum swing angle that the wrench can be turned to wrench an object. The pawl includes a side thereof including a plurality of teeth. The gear wheel is rotatable with respect to an axis and includes an annular outer periphery including a plurality of teeth. The teeth of the pawl is clutched with a portion of the plurality of teeth of the gear wheel and the gear wheel is prevented from rotation when the object is turned by the wrench, and the gear wheel is rotated relative to the pawl and includes the teeth movably engaging with the teeth of the pawl when the wrench is turned relative to the object. Generally, if the wrench is a compact wrench, the teeth of the pawl and the gear wheel are manufactured with relative small shapes in order to fit into the compact wrench. However, the compact wrench can not withstand large torque transmission.

The present invention is, therefore, intended to obviate or at least alleviate the problems encountered in the prior art.

### SUMMARY OF THE INVENTION

According to the present invention, a ratchet wrench includes a head. A gear wheel, a first pawl, and a second pawl are disposed in a chamber defined in the head. The gear wheel has an outer periphery thereof including a plurality of teeth extended circumferentially outwardly therefrom. The first and second pawls each include a lateral side thereof including third and fourth plurality of teeth respectively extended outwardly therefrom. The first and second pawls are disposed one above the other. The first and second pawls are respectively biased by first and second biasing mechanisms. The first and second pawls are alternatively engaged with the gear wheel when it is operably turned.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an objective of the present invention to provide a ratchet wrench which better withstands torque transmission and is capable of being operated through a relatively smaller minimum swing angle action.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a driving end of a ratchet wrench in accordance with a first embodiment of the present invention.

FIG. 2 is an exploded perspective view of FIG. 1.

FIG. 3 is a partial cut-out view of FIG. 1.

FIG. 4 is a cross-sectional view of FIG. 1.

FIG. 5 is a cross-sectional view taken along line 5-5 of FIG. 4.

FIG. 6 is a cross-sectional view taken along line 6-6 of FIG. 4.

FIG. 7 is a continued view of FIG. 6 and shows the operation of the ratchet wrench in a first operation direction, with the arrow indicating the first operating direction.

FIG. 8 is a continued view of FIG. 5 and shows the operation of the ratchet wrench in the first operating direction.

FIG. 9 is an exploded perspective view of a driving end of a ratchet wrench in accordance with a second embodiment of the present invention.

FIG. 10 is a cross-sectional view of FIG. 9.

FIG. 11 is a cross-sectional view taken along line 11-11 of FIG. 10.

FIG. 12 is a cross-sectional view taken along line 12-12 of FIG. 10.

FIG. 13 is an exploded perspective view of a driving end of a ratchet wrench in accordance with a third embodiment of the present invention.

FIG. 14 is another exploded perspective view of the third embodiment.

FIG. 15 is a top view showing first and second pawls of the ratchet wrench of FIG. 13 overlapped vertically, and the first pawl offset from the second pawl horizontally.

FIG. 16 is a cross-sectional view of the ratchet wrench of FIG. 13 and shows the first and second pawls alternatively engaged with a gear wheel of the ratchet wrench.

FIG. 17 is an extended cross-sectional view of FIG. 16 showing the second pawl engaged with the gear wheel.

FIG. 18 is an exploded perspective view of a driving end of a ratchet wrench in accordance with a fourth embodiment of the present invention.

### DETAILED DESCRIPTION OF THE INVENTION

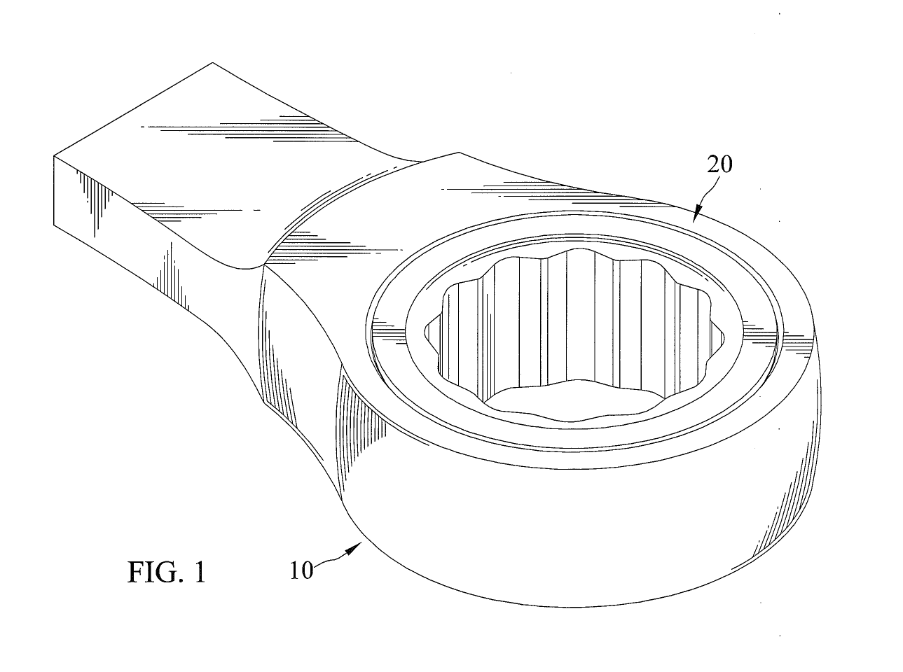

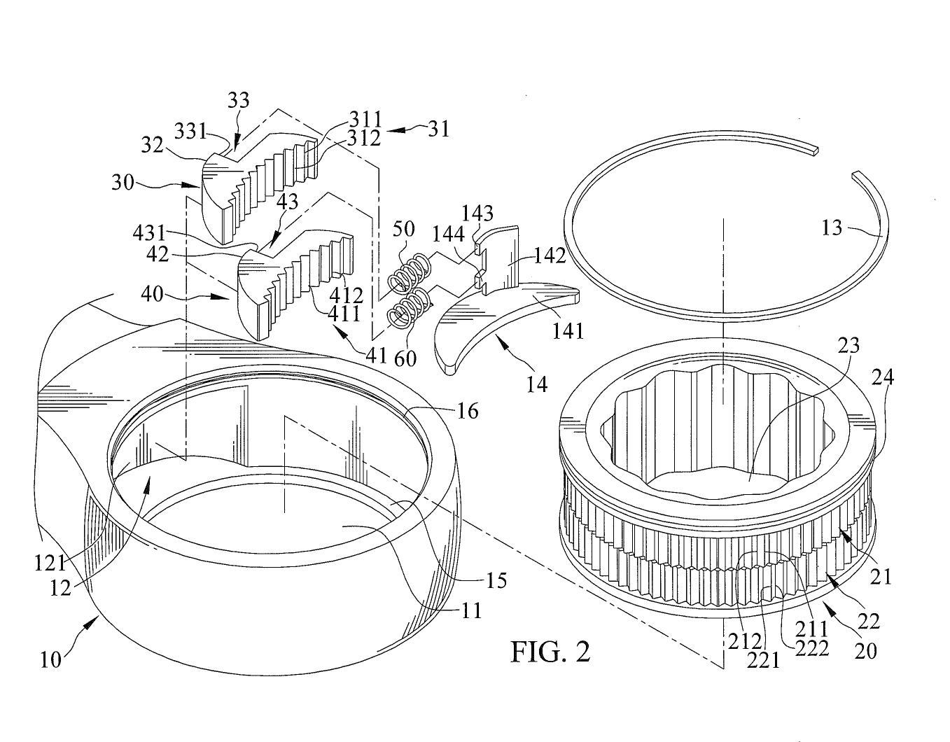

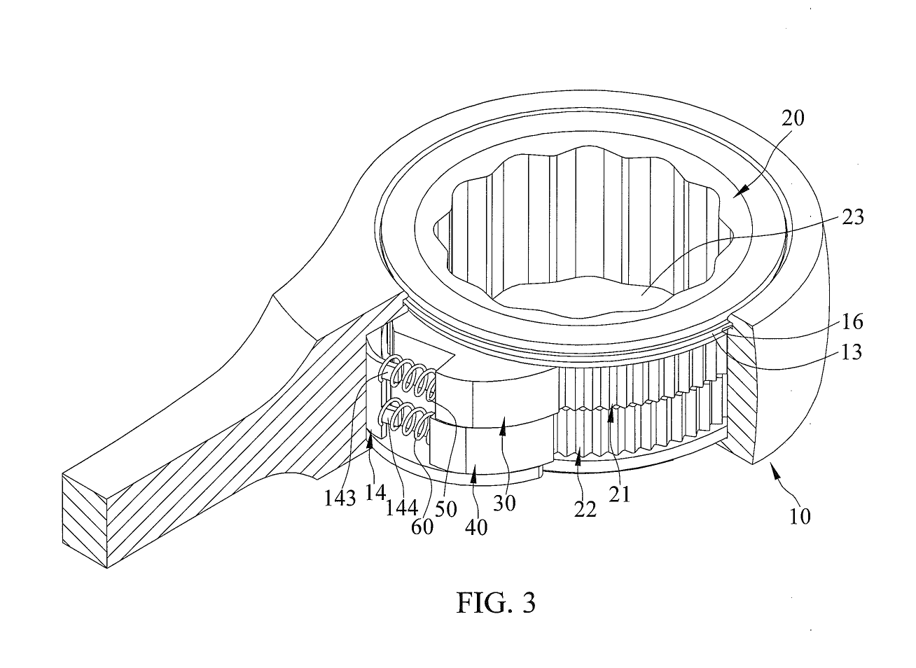

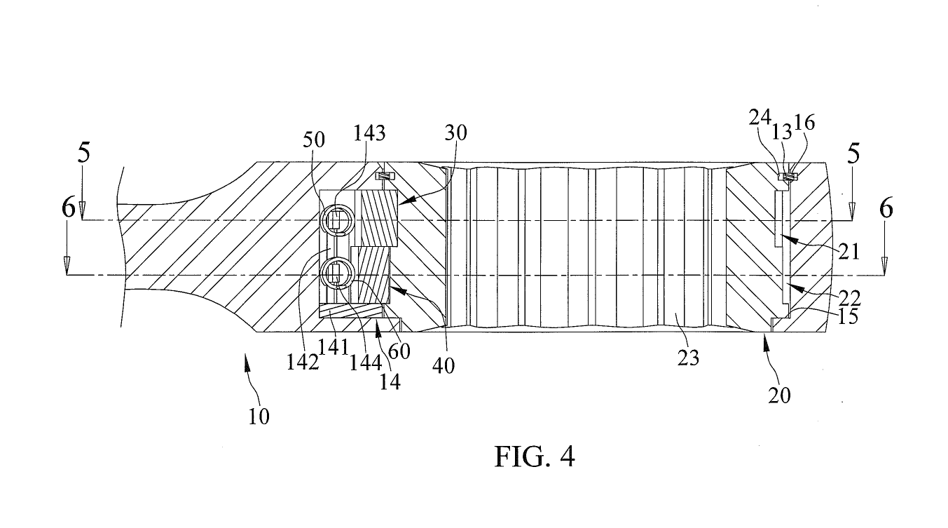

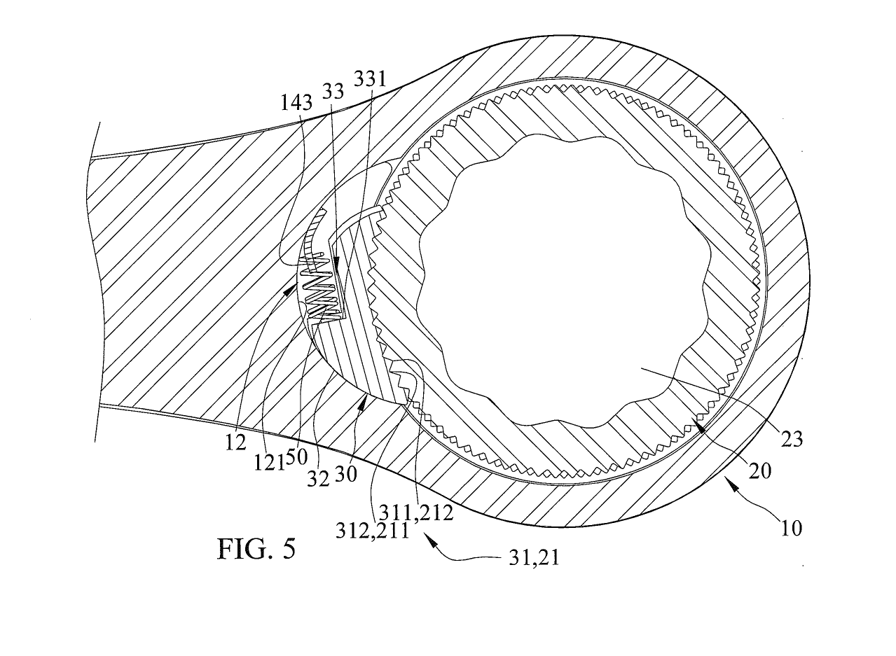

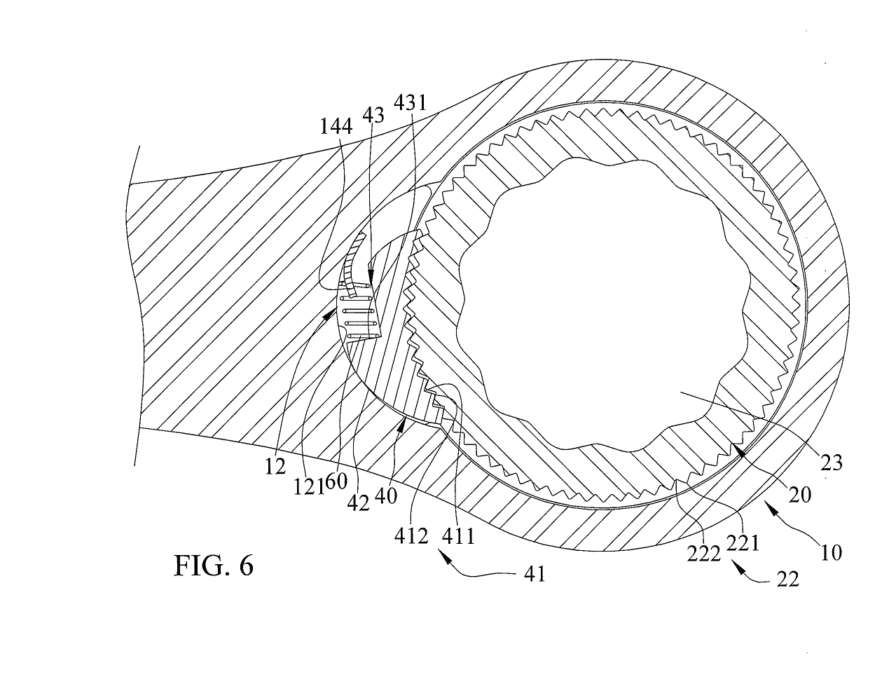

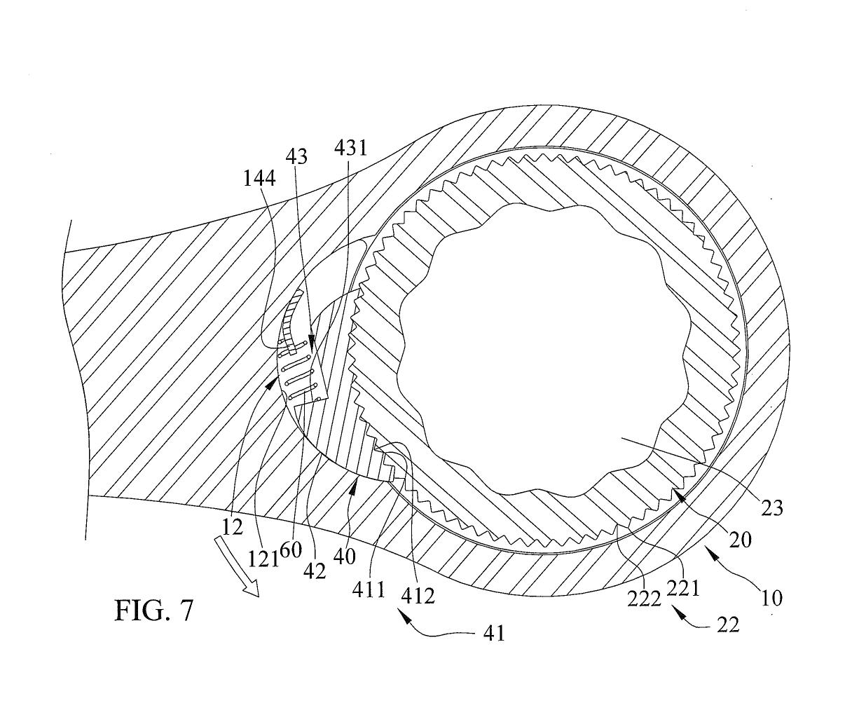

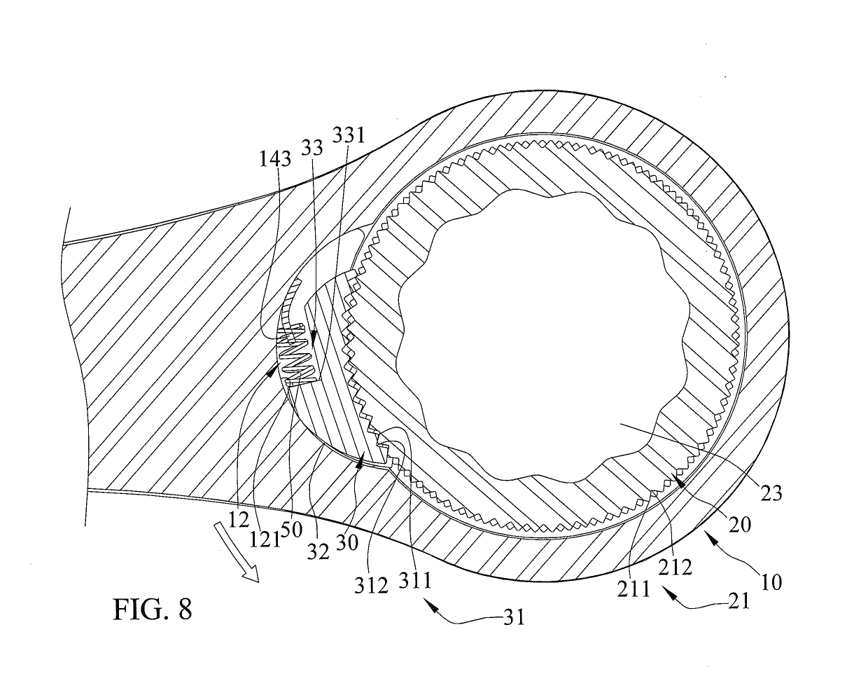

FIGS. 1 through 8 show a ratchet wrench capable of being operated through a relatively smaller minimum swing angel action in accordance with a first embodiment of the present invention. The adjustable wrench includes a head 10. The head 10 includes a chamber defined therein, and a gear wheel 20, a first pawl 30, and a second pawl 40 are disposed in the chamber. The chamber defines first and second compartments 11 and 12. The gear wheel 20 is disposed in the first compartment 11. A flange 15 is extended circumferentially from a wall delimiting the first compartment 11 for bearing the gear wheel 20. A groove 16 is extended circumferentially from the first compartment 11. The gear wheel 20 has an outer periphery thereof including a channel 24 circumferentially inset therein. An annular clip 13 is partially engaged in the groove 16 and partially in the channel 24 to lock the gear wheel 20 to the head 10. The first and second pawls 30 and 40 are disposed in the second compartment 12. The second compartment 12 has an arcuate lateral wall 121.

The gear wheel 20 is adapted to directly engage with an object that is to be driven by the ratchet wrench, with the object engaged in an engaging hole 23. The engaging hole 23 is extended circumferentially, and a wall delimiting the engaging hole 23 includes a plurality of ridges extended therefrom, which improves friction with the object. The gear wheel 20 includes an enclosed annular outer periphery, and which includes a plurality of teeth extended circumferentially outwardly therefrom. The plurality of teeth defines first and second plurality of teeth 21 and 22 respectively extended circumferentially outwardly on the outer periphery of the gear wheel 20 at first and second heights. The first plurality of teeth 21 are adjacent to one another. The second plurality of teeth 22 are adjacent to one another. Tooth profiles of each of the first plurality of teeth 21 and each of the second plurality of teeth 22 are the same. The first plurality of teeth 21 are circumferentially offset relative to the second plurality of teeth 22. Each of the first plurality of teeth 21 has a top edge 211, and a bottom edge 222 defining an interconnecting edge of two adjacent teeth of the second plurality of teeth 22 is aligned with the top edge 211. Each of the second plurality of teeth 22 has a top edge 221, and a bottom edge 212 defining an interconnecting edge of two adjacent teeth of the first plurality of teeth 21 is aligned with the top edge 212.

Two pawls of the same shape defining the first and second pawls 30 and 40. The first and second pawls 30 and 40 are disposed one above the other. The first pawl 30 is offset from the second pawl 40 horizontally. The first pawl 30 includes a lateral side thereof including a third plurality of teeth 31 extended outwardly therefrom. The second pawl 40 includes a lateral side thereof including a fourth plurality of teeth 41 extended outwardly therefrom. Each of the third plurality of teeth 31 has a top edge 311, and a bottom edge 412 defining an interconnecting edge of two adjacent teeth of the fourth plurality of teeth 41 is aligned with the top edge 311. Each of the fourth plurality of teeth 41 has a top edge 411, and a bottom edge 312 defining an interconnecting edge of two adjacent teeth of the third plurality of teeth 31 is aligned with the top edge 411. The first and second pawls 30 and 40 each include the lateral side thereof forming an arcuate side 32 and 42 slidably abutted against the arcuate lateral wall of the second compartment 12. The first pawl 30 includes the arcuate side 32 opposite the third plurality of teeth 31. The second pawl 40 includes the arcuate side 42 opposite the fourth plurality of teeth 41.

The first and second pawls 30 and 40 are moved and alternatively engage with the gear wheel 20 when it is operably turned, and the first and second pawls 30 and 40 move in an arcuate path. The first and second pawls 30 and 40 selectively engage with and disengage from the first and second plurality of teeth 21 and 22, respectively.

The first and second pawls 30 and 40 are independently biased by first and second biasing mechanisms 50 and 60. Two springs each have a plurality of coaxial coils are used as first and second biasing mechanisms 50 and 60. The compartment 12 receives a retaining structure 14 for retaining first and second biasing mechanisms 50 and 60. The retaining structure 14 has first and second retaining ends 143 and 144 extended at different heights. The retaining structure 14 includes the first and second retaining ends 143 and 144 defining two protruded sections extended at different heights. The retaining structure 14 has a base 141 and an extension 142 extended from the base 141. The base 141 has a substantially crescent-shaped lateral contour, and which defines an arcuate edge abutted against and conforming to the arcuate lateral wall 121 of the second compartment 12, so the retaining structure 14 is stably disposed in the second compartment 12. The base 141 can be eliminated. The extension 142 can be welded so that it is stably disposed. The extension 142 is extended in a direction substantially perpendicularly from the base 141. The first and second retaining ends 143 and 144 are extended in a direction substantially perpendicularly from the extension 142 and in the same direction, and the extension 142 and the first and second retaining ends 143 and 144 forms a substantially F-shaped structure. The first and second biasing mechanisms 50 and 60 each include a first end respectively held on the first and second retaining ends 143 and 144, and a second end respectively abutted against the first and second pawls 30 and 40.

The second ends of the first and second biasing mechanisms 50 and 60 are respectively retained in a recessed area 33 inset on the lateral side of the first pawl 30 and a recessed area 43 inset on the lateral side of the second pawl 40. The recessed area 33 forms an engaging side 331 which is substantially a flat surface and against which the first biasing mechanism 50 abuts. The recessed area 43 forms an engaging side 431 which is substantially a flat surface and against which the second biasing mechanism 60 abuts. The recessed areas 33 and 43 are respectively opposite the third and fourth plurality of teeth 31 and 41.

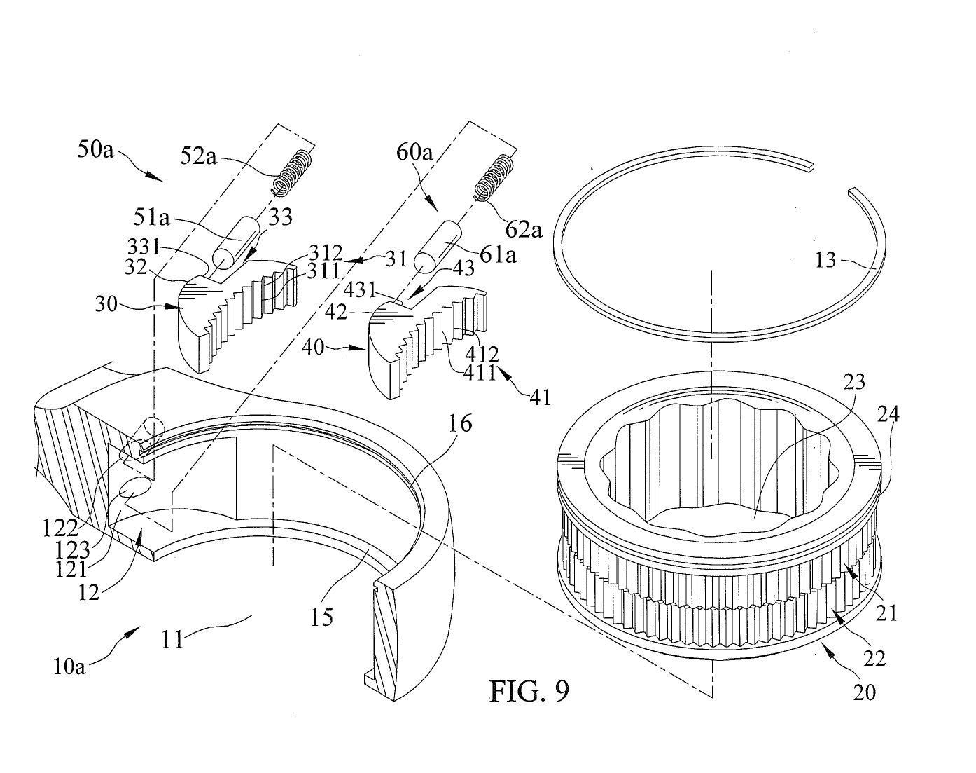

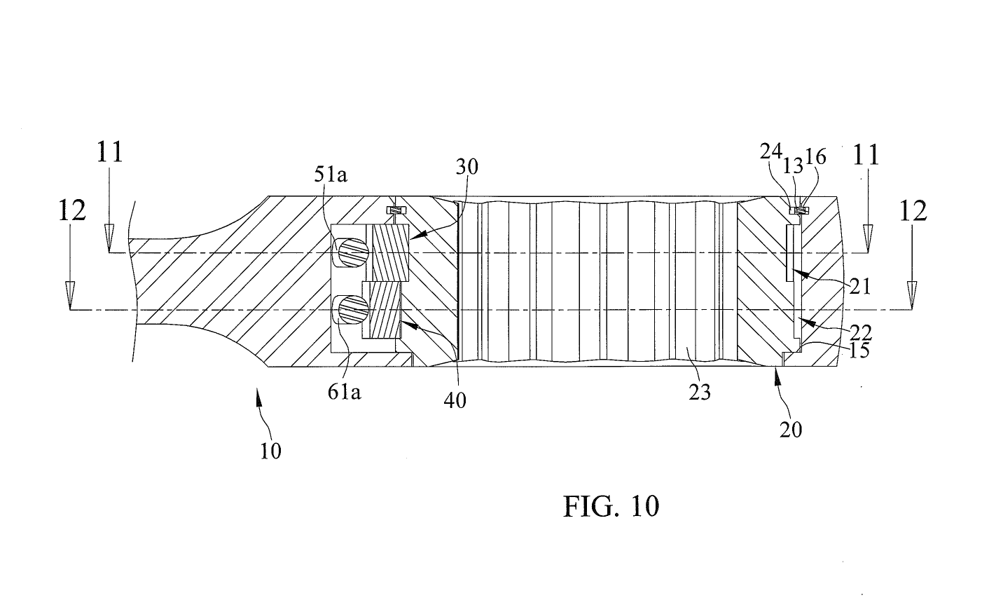

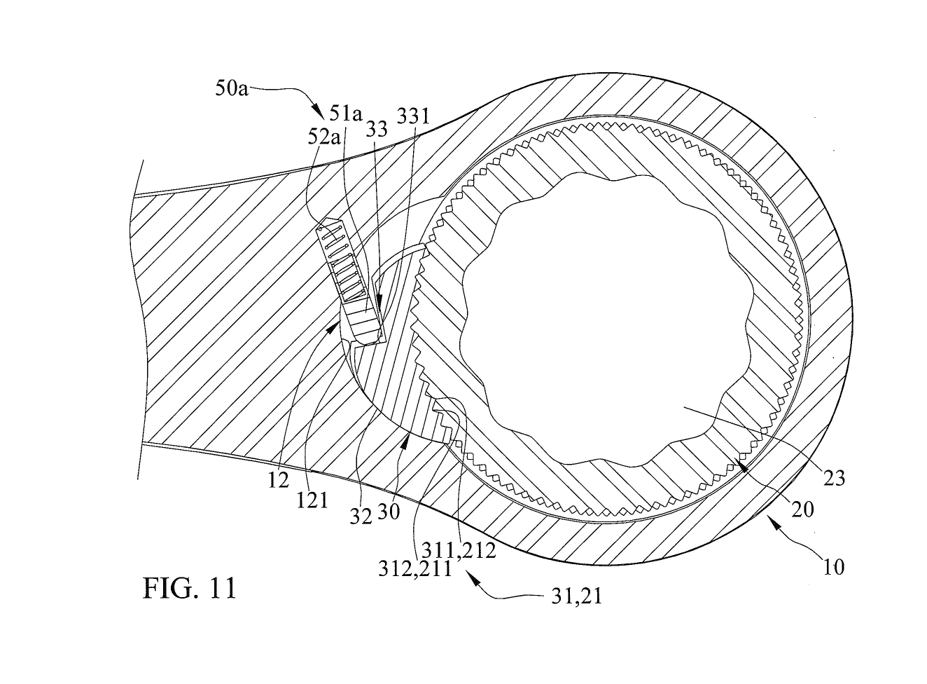

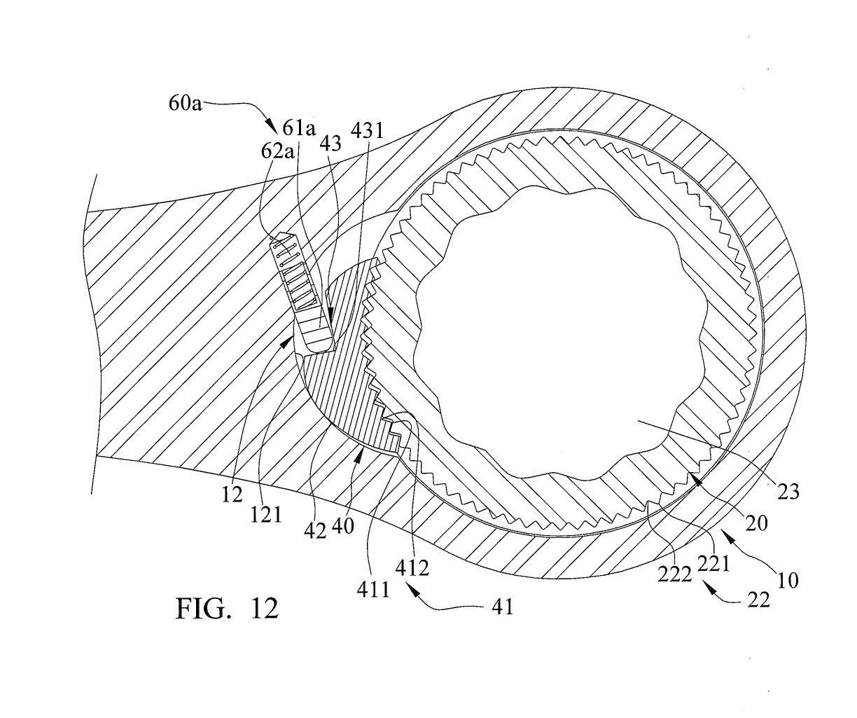

FIGS. 9 through 12 show a ratchet wrench in accordance with a second embodiment of the present invention. The second embodiment is similar to the first embodiment except a head 10a replaces the head 10. The head 10a is modified from the head 10 to include two receptacles 122 and 123 extended from the chamber. Additionally, first and second biasing mechanisms 50a and 60a respectively replace the first and second biasing mechanisms 50 and 60. The first and second biasing mechanisms 50a and 60a each include a pusher 51a and 61a and a biasing element 52a and 62a, and the first and second biasing mechanisms 50a and 60a include the associated biasing elements 52a and 62a each having a first end retained in one receptacle 122 or 123 and a second end abutted against the associated pusher 51a and 61a. The first and second biasing mechanisms 50a and 60a also include the associated pusher 51a and 61a respectively abutted against the first and second pawls 30 and 40.

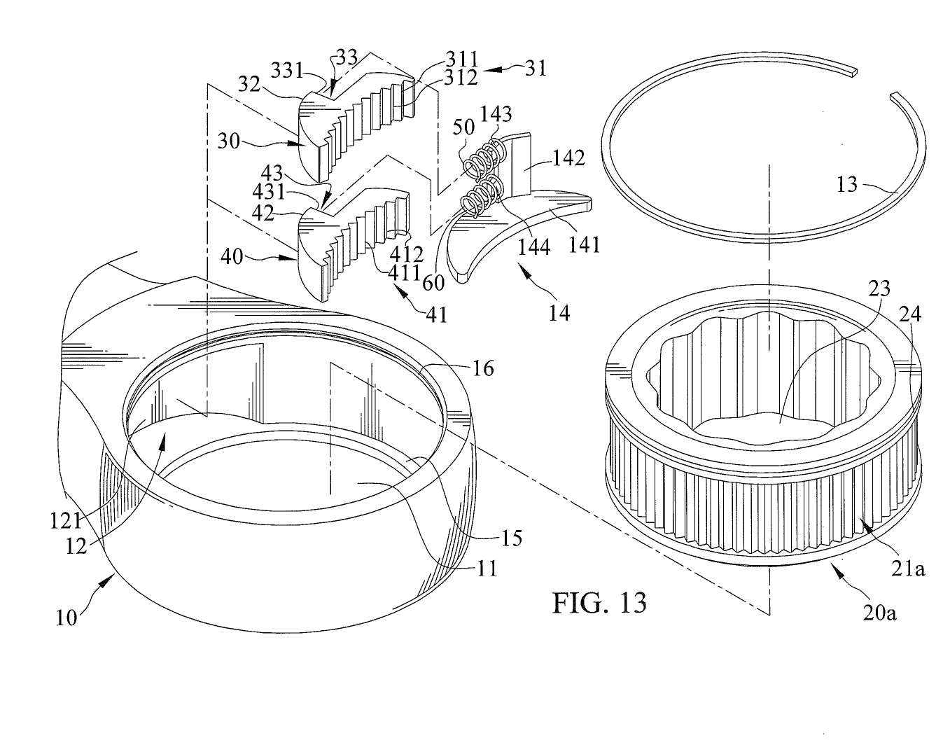

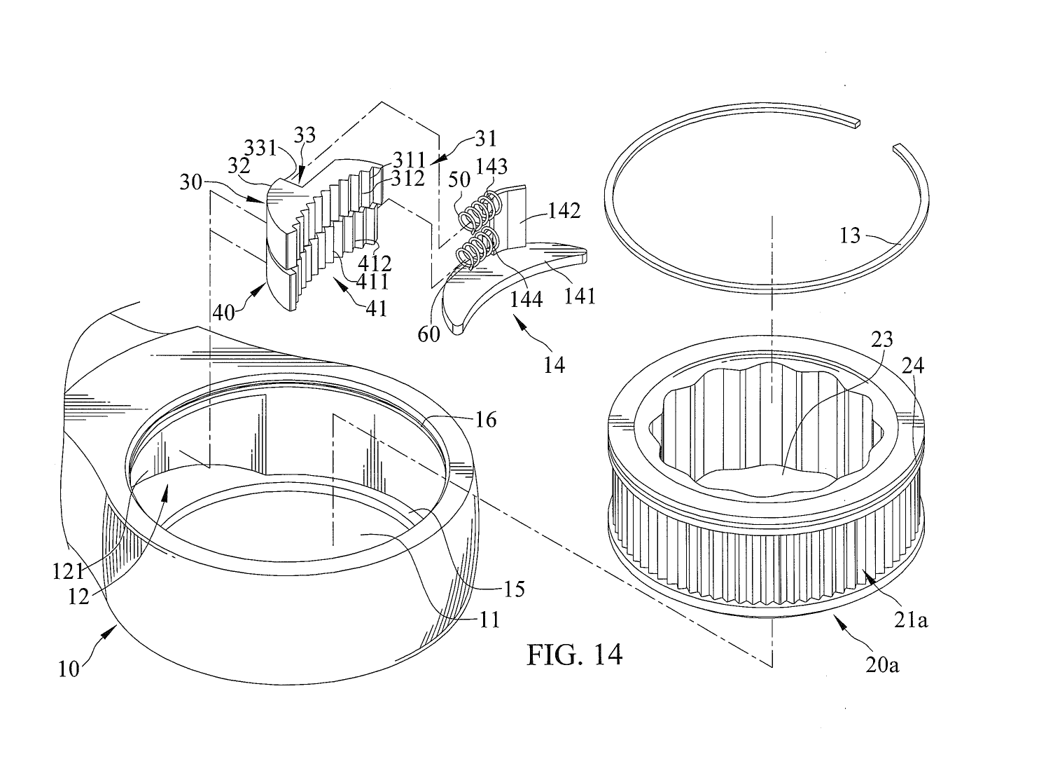

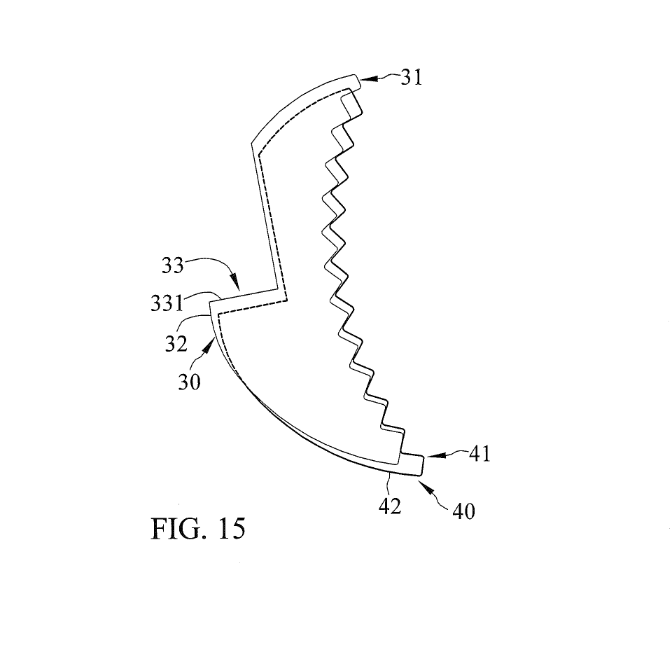

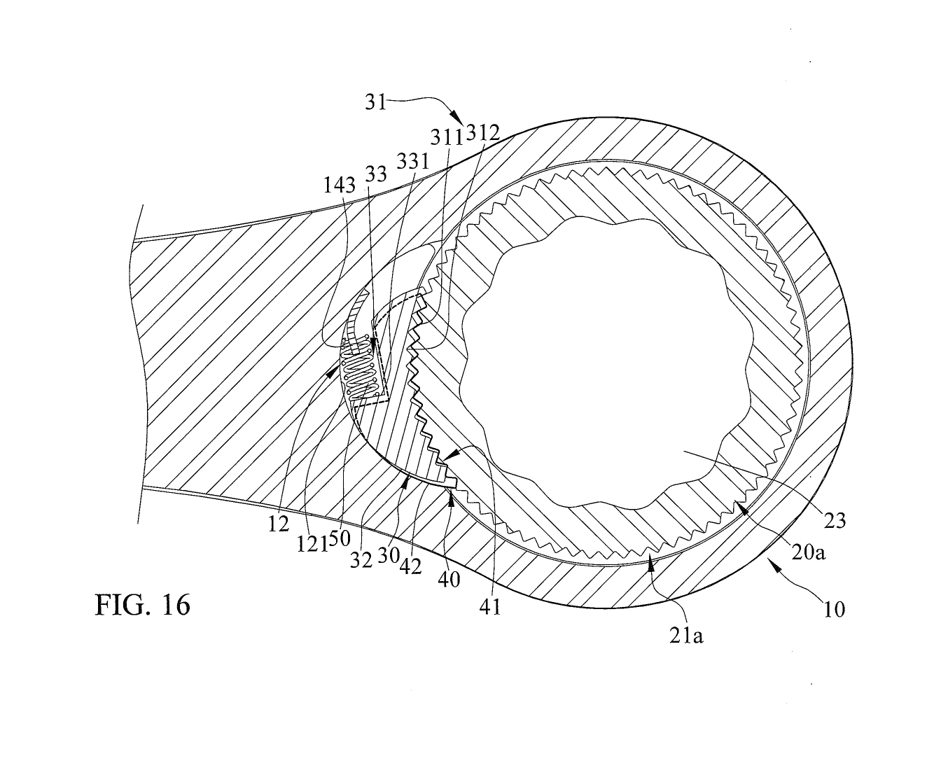

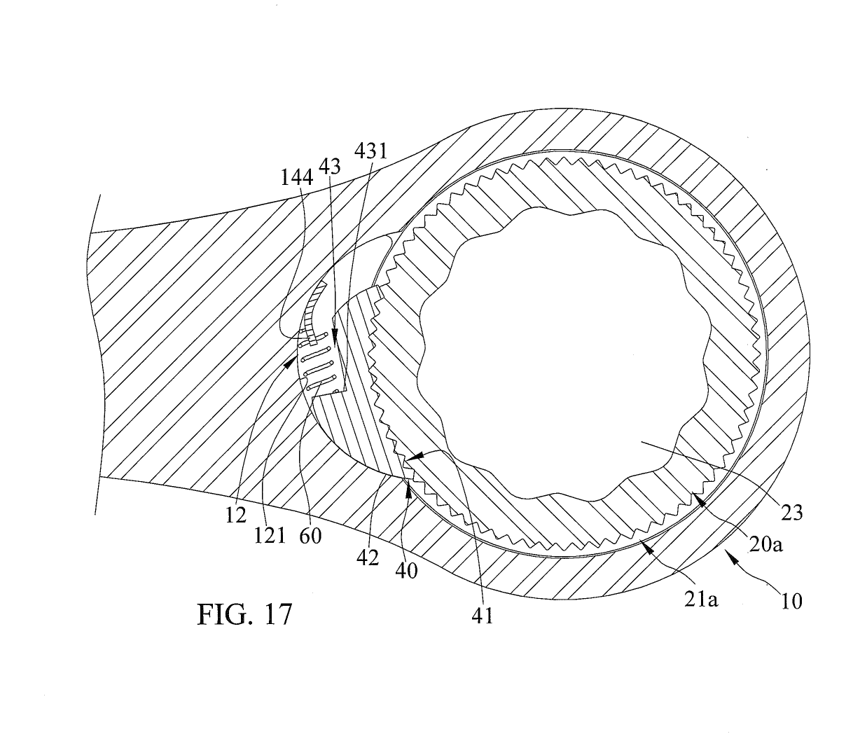

FIGS. 13 through 17 show a ratchet wrench in accordance with a third embodiment of the present invention. The third embodiment is similar to the first embodiment except a gear wheel 20a replaces the gear wheel 20. The gear wheel 20a is modified from the gear wheel 20 to eliminate the second plurality of teeth 22 and to make each of the first plurality of teeth 21 have a longer longitudinal length. The modified first plurality of teeth is numbered as 21a.

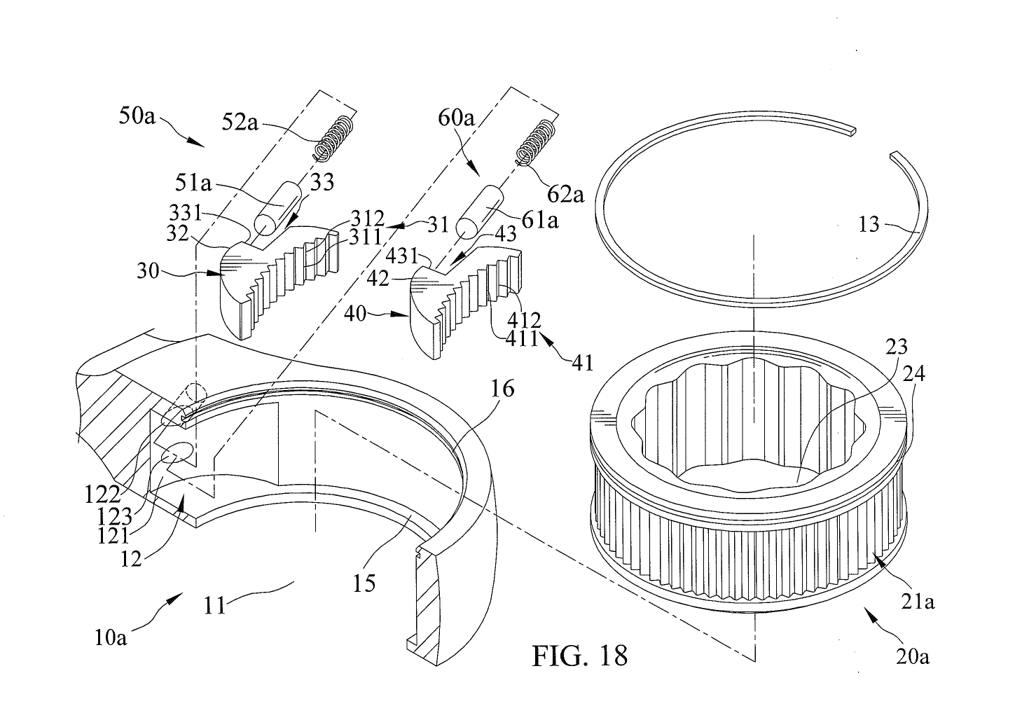

FIG. 18 shows a ratchet wrench in accordance with a fourth embodiment of the present invention. The fourth embodiment is similar to the second embodiment except the gear wheel 20a in the third embodiment replaces the gear wheel 20.

In view of the forgoing, the first plurality of teeth 21 are circumferentially offset relative to the second plurality of teeth 22, or the first pawl 30 is horizontally offset relative to the second pawl 40 in order to make the first and second pawl 30 and 40 alternatively engage with the gear wheel 20, 20a when it is operably turned, and to make the ratchet wrench have a relatively smaller minimum swing angel action without reducing each of the first, second, third, and fourth plurality of teeth 21 and 22 to a size that is liable to become damaged easily when subject to a larger torque transmission.

While the specific embodiments have been illustrated and described, numerous modifications come to mind without significantly departing from the spirit of invention, and the scope of invention is only limited by the scope of the accompanying claims.

What is claimed is:

1. A ratchet wrench capable of being operated through a relatively smaller minimum swing angel action, comprising:
a head; and
a gear wheel, a first pawl, and a second pawl disposed in a chamber defined in the head, wherein the gear wheel has an outer periphery thereof including a plurality of teeth extended circumferentially outwardly therefrom, wherein the first and second pawls each include a lateral side thereof including third and fourth plurality of teeth respectively extended outwardly therefrom, wherein the first and second pawls are disposed one above the other, wherein the first and second pawls are respectively biased by first and second biasing mechanisms, wherein the first and second pawl are alternatively engaged with the gear wheel when it is operably turned.

2. The ratchet wrench as claimed in claim 1, wherein the chamber receives a retaining structure for retaining first and second biasing mechanisms, wherein the retaining structure has first and second retaining ends extended at different heights, and wherein the first and second biasing mechanisms each include a first end respectively held on the first and second retaining ends, and a second end respectively abutted against the first and second pawls.

3. The ratchet wrench as claimed in claim 2, wherein the retaining structure has an extension, and the first and second retaining ends are extended in a direction substantially perpendicularly from the extension and in the same direction.

4. The ratchet wrench as claimed in claim 3, wherein the retaining structure has a base, and wherein the extension is extended from the base, wherein the extension is extended in a direction substantially perpendicularly from the base.

5. The ratchet wrench as claimed in claim 1, wherein two receptacles are extended from the chamber, wherein the first and second biasing mechanisms each include a pusher and a biasing element, and the first and second biasing mechanisms include the associated biasing elements each having a first end retained in one receptacle and a second end abutted against the associated pusher, and wherein the first and second biasing mechanisms include the associated pusher respectively abutted against the first and second pawls.

6. The ratchet wrench as claimed in claim 2, wherein the chamber has an arcuate lateral wall and the first and second pawls each include the lateral side thereof forming an arcuate side slidably abutted against the arcuate lateral wall of the second compartment, and wherein the first and second pawls move in an arcuate path when it is operably turned.

7. The ratchet wrench as claimed in claim 5, wherein the chamber has an arcuate lateral wall and the first and second pawls each include the lateral side thereof forming an arcuate side slidably abutted against the arcuate lateral wall of the second compartment, and wherein the first and second pawls move in an arcuate path when it is operably turned.

8. The ratchet wrench as claimed in claim 2, wherein a groove is extended circumferentially from the chamber in the head, wherein the gear wheel has the outer periphery thereof including a channel circumferentially inset therein, and wherein an annular clip is partially engaged in the groove and partially in the channel.

9. The ratchet wrench as claimed in claim 5, wherein a groove is extended circumferentially from the chamber in the head, wherein the gear wheel has the outer periphery thereof including a channel circumferentially inset therein, and wherein an annular clip is partially engaged in the groove and partially in the channel.

10. The ratchet wrench as claimed in claim 1, wherein the plurality of teeth define first and second plurality of teeth respectively extended circumferentially outwardly therefrom, and wherein the first plurality of teeth are circumferentially offset relative to the second plurality of teeth.

11. The ratchet wrench as claimed in claim 10, wherein each of the first plurality of teeth has a first top edge, and a bottom edge defining an interconnecting edge of two adjacent teeth of the second plurality of teeth is aligned with the first top edge, wherein each of the second plurality of teeth has a second top edge, and a bottom edge defining an interconnecting edge of two adjacent teeth of the first plurality of teeth is aligned with the second top edge, wherein each of the third plurality of teeth has a third top edge, and a bottom edge defining an interconnecting edge of two adjacent teeth of the fourth plurality of teeth is aligned with the third top edge, and wherein each of the fourth plurality of teeth has a fourth top edge, and a bottom edge defining an interconnecting edge of two adjacent teeth of the third plurality of teeth is aligned with the fourth top edge.

12. The ratchet wrench as claimed in claim 2, wherein the plurality of teeth define first and second plurality of teeth respectively extended circumferentially outwardly therefrom, and wherein the first plurality of teeth are circumferentially offset relative to the second plurality of teeth.

13. The ratchet wrench as claimed in claim 12, wherein each of the first plurality of teeth has a first top edge, and a bottom edge defining an interconnecting edge of two adjacent teeth of the second plurality of teeth is aligned with the first top edge, wherein each of the second plurality of teeth has a second top edge, and a bottom edge defining an interconnecting edge of two adjacent teeth of the first plurality of teeth is aligned with the second top edge, wherein each of the third plurality of teeth has a third top edge, and a bottom edge defining an interconnecting edge of two adjacent teeth of the fourth plurality of teeth is aligned with the third top edge, and wherein each of the fourth plurality of teeth has a fourth top edge, and a bottom edge defining an interconnecting edge of two adjacent teeth of the third plurality of teeth is aligned with the fourth top edge.

14. The ratchet wrench as claimed in claim 5, wherein the plurality of teeth define first and second plurality of teeth respectively extended circumferentially outwardly therefrom, and wherein the first plurality of teeth are circumferentially offset relative to the second plurality of teeth.

15. The ratchet wrench as claimed in claim 14, wherein each of the first plurality of teeth has a first top edge, and a bottom edge defining an interconnecting edge of two adjacent teeth of the second plurality of teeth is aligned with the first top edge, wherein each of the second plurality of teeth has a second top edge, and a bottom edge defining an interconnecting edge of two adjacent teeth of the first plurality of teeth is aligned with the second top edge, wherein each of the third plurality of teeth has a third top edge, and a bottom edge defining an interconnecting edge of two adjacent teeth of the fourth plurality of teeth is aligned with the third top edge, and wherein each of the fourth plurality of teeth has a fourth top edge, and a bottom edge defining an interconnecting edge of two adjacent teeth of the third plurality of teeth is aligned with the fourth top edge.

16. The ratchet wrench as claimed in claim 1, wherein the chamber has an arcuate lateral wall and the first and second pawls each include the lateral side thereof forming an arcuate side slidably abutted against the arcuate lateral wall of the second compartment, and wherein the first and second pawls move in an arcuate path when it is operably turned.

17. The ratchet wrench as claimed in any of claim 1, wherein a groove is extended circumferentially from the chamber in the head, wherein the gear wheel has the outer periphery thereof including a channel circumferentially inset therein, and wherein an annular clip is partially engaged in the groove and partially in the channel.
